(19) United States
(12) Patent Application Publication
(10) Pub. No.: US 2023/0114694 A1
(43) Pub. Date: Apr. 13, 2023

(54) LIGHT COUPLING DEVICE

(71) Applicant: Quantum-Si Incorporated, Guilford, CT (US)

(72) Inventors: Gerard Schmid, Guilford, CT (US); Ali Kabiri, Guilford, CT (US); Seled Ali Safiabadi Tali, New Haven, CT (US)

(21) Appl. No.: 17/962,376

(22) Filed: Oct. 7, 2022

Related U.S. Application Data
(60) Provisional application No. 63/254,330, filed on Oct. 11, 2021.

(51) Int. Cl. G01N 21/64; G01N 21/45

(52) U.S. Cl. CPC G01N 21/6428; G01N 21/45; G01N 2021/4166

(57) ABSTRACT

An integrated device, comprising a substrate having a first surface; and at least one pixel formed on or in the substrate. The at least one pixel comprising a reaction chamber configured to receive a sample, and a sensor configured to detect emission light emitted from the reaction chamber and at least one nanostructure disposed in a plane between a waveguide and the sensor, wherein the optical nanostructure is configured to converge at least a portion of the emission light in a direction substantially perpendicular to the plane. The waveguide is configured to couple excitation light to each pixel.

### CROSS-REFERENCE TO RELATED APPLICATION

This application claims the benefit of U.S. Provisional Patent Application Ser. No. 63/254,330, filed Oct. 11, 2021, entitled “LIGHT COUPLING DEVICE,” which is incorporated herein by reference in its entirety.

### FIELD

The present application relates to improving, with optical nanostructures, the performance of an instrument that analyzes samples.

### BACKGROUND

In the area of instrumentation that is used for analysis of samples, microfabricated chips may be used to analyze in parallel a large number of analytes or specimens contained within one or more samples. In some cases, optical excitation radiation is delivered to multiple discrete sites on a chip at which separate analyses are performed. The excitation radiation may excite a specimen at each site, a fluorophore attached to the specimen, or a fluorophore involved in an interaction with the specimen. In response to the excitation, radiation may be emitted from a site and the emitted radiation for a site, or lack of emitted radiation, can be used to determine a characteristic of the specimen at that site.

### SUMMARY OF THE DISCLOSURE

An integrated device, comprising a substrate having a first surface; and at least one pixel formed on or in the substrate. The at least one pixel comprising a reaction chamber configured to receive a sample, and a sensor configured to detect emission light emitted from the reaction chamber and at least one optical nanostructure disposed in a plane between a waveguide and the sensor, wherein the optical nanostructure is configured to converge at least a portion of the emission light in a direction substantially perpendicular to the plane. The waveguide is configured to couple excitation light to each pixel.

An integrated device, comprising a substrate having a first surface, and at least one pixel formed on the substrate. The at least one pixel comprising a reaction chamber configured to receive a sample, a sensor configured to detect emission light emitted from the reaction chamber, a waveguide configured to couple excitation radiation to the reaction chamber, a photonic disk disposed in a plane between the waveguide and the sensor, and at least one nanostructure ring disposed in a plane between the waveguide and the sensor, the photonic disk and nanostructure ring are configured to converge at least a portion of the emission light in a direction substantially perpendicular to the plane.

A method for fabricating an integrated device, the method comprising forming, on a substrate having a first surface, a plurality of pixels such that at least some of the plurality of pixels. Forming each a pixel comprises forming a reaction chamber configured to receive a sample, and forming a sensor configured to detect emission light emitted from the reaction chamber, and fabricating the integrated device further includes forming a waveguide configured to couple excitation radiation to the reaction chamber. The method further comprising forming at least one nanostructure in a plane between the waveguide and the sensor, wherein the optical nanostructure is configured to converge at least a portion of the emission light in a direction substantially perpendicular to the plane.

The foregoing and other aspects, implementations, acts, functionalities, features, and embodiments of the present application can be more fully understood from the following description in conjunction with the accompanying drawings.

### BRIEF DESCRIPTION OF THE DRAWINGS

FIGS. 1A and 1B illustrate an exemplary pixel of an integrated device.

FIG. 1C illustrates exemplary emission spectra of emitters that may be used in accordance with some embodiments.

FIGS. 2A-2C illustrates an exemplary pixelated pattern of photonic structures, in accordance with some embodiments.

FIGS. 3A-3C illustrated information about emission light in accordance with some embodiments.

FIGS. 4A-4C illustrate an exemplary merged pattern of photonic structures, in accordance with some embodiments.

FIGS. 5A-5C illustrate information about an electric field of an emitter in a sample well of an integrated device that includes the photonic structures of FIGS. 4A-4C, in accordance with some embodiments.

FIGS. 6A-6B illustrate another exemplary pattern of photonic structures, in accordance with some embodiments.

FIGS. 7A-7C illustrate information about an electric field of an emitter in a sample well of the integrated device that includes the photonic structures of FIGS. 6A-6B, in accordance with some embodiments.

FIGS. 8A-8C illustrate an exemplary embodiment of an enhanced microdisk, in accordance with some embodiments.

FIGS. 9A-9C illustrate information about an electric field of an emitter in a sample well of the integrated device that includes the photonic structures of FIGS. 8A-8C, in accordance with some embodiments.

FIGS. 10A and 10B illustrate another exemplary embodiment of an enhanced microdisk, in accordance with some embodiments.

FIGS. 11A-11C illustrate information about an electric field of an emitter in a sample well of the integrated device that includes the photonic structures of FIGS. 10A-10B, in accordance with some embodiments.

FIGS. 12A and 12B illustrate another exemplary embodiment of an enhanced microdisk, in accordance with some embodiments.

FIGS. 13A-13C illustrate information about an electric field of an emitter in a sample well of the integrated device that includes the photonic structures of FIGS. 12A-12B, in accordance with some embodiments.

FIG. 14 illustrates a process 1400 for designing the photonic structures for use in an integrated device, in accordance with some embodiments.

FIG. 15A shows a graph of measured refractive indices and extinction coefficients of a silicon-rich nitride material, in accordance with some embodiments.

FIG. 15B illustrates the wavelength dependent refractive index and extinction coefficient for an exemplary silicon-rich nitride material.

FIG. 16 illustrates a process 1600 of manufacturing photonic structures, in accordance with some embodiments described herein.

### DETAILED DESCRIPTION

Aspects of the present application relate to photonic structures for use in integrated devices, instruments, and related systems capable of analyzing samples in parallel including identification of single molecules and nucleic acid and/or protein sequencing. In some applications, such an integrated device may benefit from the inclusion of photonic structures to couple light from a sample well to a detector. Photonic structures may increase the flux of light transmitted from the sample well to the detector and/or may concentrate the light at the detector. Increasing the flux of light transmitted to the detector and/or concentrating the light at the detector may provide larger electric fields at the detector. By providing larger electric fields at the detector, the photonic structures may increase signal-to-noise. According to some embodiments, the photonic structures may support decreased pixel sizes by concentrating emission light within a smaller area. By concentrating the emission light, a smaller detector can be used to capture the emission light.

In an integrated device, sample wells may be configured for single molecule nucleic acid and/or protein identification. To identify the single molecule nucleic acids and/or proteins contained within a sample, excitation light is transmitted to the sample wells containing the sample. Following excitation, the sample or a tag thereon may emit fluorescence. An on-chip detector may be used to detect the fluorescent light emitted from the sample, and using the detected light, information about the sample, such as the identity of the single molecule nucleic acid and/or protein, is determined. Detectors and sample wells may be grouped into pixels to provide an integrated device capable of parallel identification and/or sequencing. For example, an integrated device may have multiple pixels, where each pixel includes a detector configured to detect light, detector electronics to process the signals associated with the detector, and a sample well.

The inventors have recognized and appreciated that the pixel size, in an integrated device, may limit the number of single molecule nucleic acid and/or protein identifications that may be performed in parallel. The inventors have further appreciated that the size of the detector impacts the pixel size. Thus, smaller sensors, may provide for increases in the parallel identifying and/or sequencing capacity. However, the intensity of a single molecule emitter in a sample well may be low relative to the intensity of scattered excitation light that reaches the detector. Further, the portion of light that is detected by the detector may impact the signal to noise. When the sensor detects every photon emitted from the sample chamber, and the detector does not receive scattered excitation light, the integrated device may produce high signal-to-noise measurements.

The inventors have recognized and appreciated that photonic structures may be used to increase the transmission of light from the sample well to the detector. However, the implementing photonic structures to control the transmission of light to the detector provides challenges. For example, if portions of the emitted light are not transmitted to the detector either because the detector is too small to capture all of the emitted light, or because portions of the emitted light are emitted in directions away from the detector, then the signal-to-noise of the integrated device may be decreased.

Additionally, the sample spot (i.e., the area of the transmitted light in the detector at the sample plane) may also impact the signal-to-noise. For example, the alignment between the transmitted sample spot and the detector will impact the signal-to-noise. Light that is transmitted to the sample plane but does not illuminate the detector will not contribute to the detected signal. Additionally, light that is not absorbed by the detector may scatter around inside the device. In some applications, the electronic detection components are also sensitive to light. Thus, scattered light may induce noise in the electronic detection components, decreasing the signal-to-noise.

The inventors have recognized and appreciated that photonic structures included with the integrated device to facilitate the transmission of light from the sample well to the detector may create challenges in fabrication. For example, as features get taller (i.e., height perpendicular to the substrate surface), fabrication techniques may introduce fabrication defects and/or strain in the layers of the integrated devices. Fabrication defects and/or strain may increase the scattering of light, which may decrease the signal-to-noise of the integrated device.

The inventors having recognized the challenges described above have developed photonic structures with multiple optical components for use in an integrated device and configured to modify the transmission of light from the sample well to the detector. Some embodiments are directed to systems, methods, and techniques for providing an integrated device that include a substrate having a first surface with at least one pixel formed on the substrate. The at least one pixel including a reaction chamber configured to receive a sample, a sensor configured to detect emission light emitted from the reaction chamber, and the integrated device further including a waveguide configured to couple excitation radiation to the reaction chamber, and multiple nanostructures disposed in a plane between the waveguide and the sensor, where the optical nanostructures are configured to converge at least a portion of the emission light in a direction substantially perpendicular to the plane.

Photonic structures utilize the differences in refractive index between two or more materials to introduce amplitude and phase modulations to the transmitted light that reflect the pattern of the photonic structure. The larger the contrast in dielectric materials, the larger the amplitude and phase modulation produced by a given structure. Additionally, the thickness and the pattern of the photonic structures will impact the magnitude of the amplitude and phase shifts to the transmitted light. After the light is transmitted through the photonic structure, the amplitude and phase shift to the transmitted light varies across the photonic structure, thus as the light continues to propagate, the transmitted light interferes with itself constructively and/or destructively. In some configurations, the phase shifts may result in a focusing effect. In other configurations, the phase shifts may result in a defocusing effect. In yet other configurations, the phase shifts may result in both focusing and defocusing effects. Accordingly, while a strictly focusing effect may result in the formation of a real image and a strictly defocusing effect may result in the formation of a virtual image, mixed effects may cause the light to converge or diverge without forming an image or virtual image.

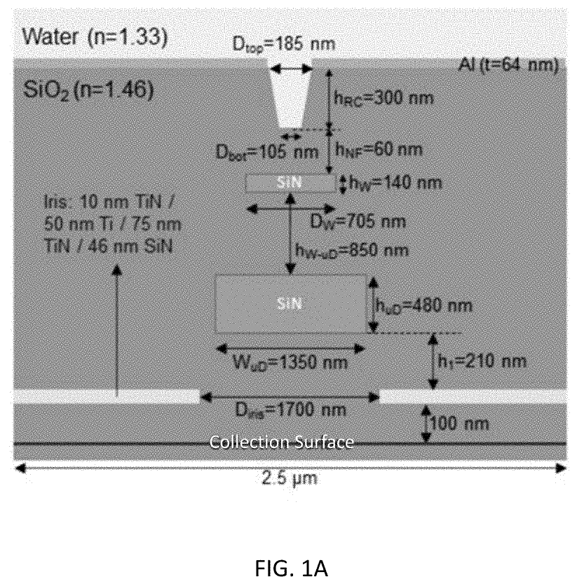

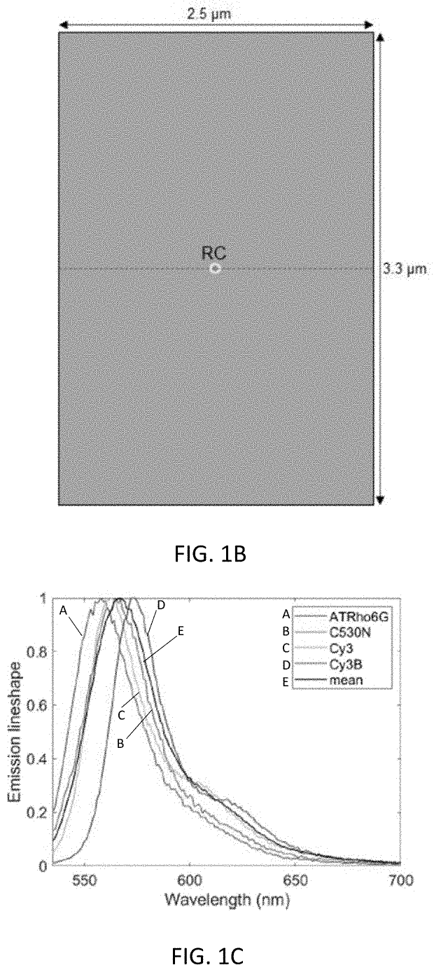

FIG. 1A illustrates an exemplary pixel of an integrated device including a sample well, excitation waveguide, silicon nitride (SiN) disk, aperture, and collection surface. A detector configured to detect light received from the sample well is configured at the collection surface. To process signals generated by the detector, detection electronics may be disposed adjacent to the detector at the collection surface. The aperture may be configured to reduce scattered light from being transmitted to the collection electronics.

FIG. 1B illustrates an exemplary pixel of an integrated device. The sample well is visible in the middle of the pixel with the other components operating within the area of pixel. Although the sample well is a small fraction of the area of pixel, the other elements, illustrated in FIG. 1A may limit the area of the pixel. For example, the detector positioned at the collection surface and the associated electronics may limit the minimum area of the pixel.

FIG. 1C illustrates exemplary emission spectra of emitters that may be used in accordance with some embodiments, as described herein. The emission spectra illustrated in FIG. 1C are normalized to the intensity at their respective wavelength of maximum emission intensity. As shown in FIG. 1C, the bandwidths of emission range from approximately 540-650 nm with a central wavelength around approximately 570 nm. In other embodiments, the central wavelength may be approximately 650 nm.

The photonic structures described herein may be configured to increase the flux transmitted to the sample plane and/or concentrate the light on the detector. In a first exemplary embodiment, a photonic structure includes multiple photonic structures that are configured in a two-dimensional pattern. The two-dimensional pattern may be centered on the z-axis in line with the sample chamber and the detector. In some embodiments, the two-dimensional pattern may be repeated for each pixel.

In some embodiments, different patterns of photonic structures may be used for different pixels of the integrated device. The pattern may be based on the center wavelength and spectral bandwidth of the light transmitted through the pixel.

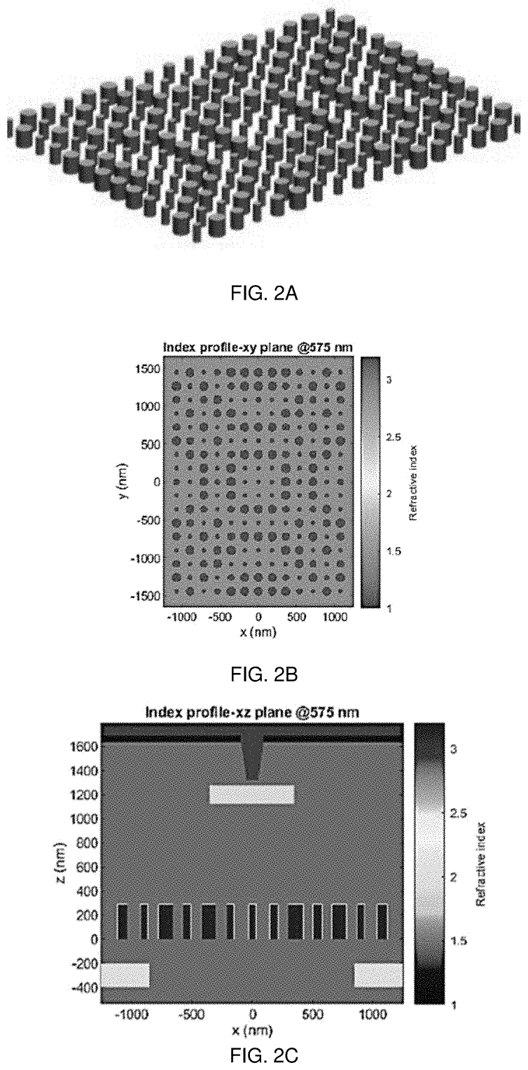

FIG. 2A illustrates an exemplary pixelated pattern of photonic structures, in accordance with some embodiments. As shown in FIG. 2A, the spacing between adjacent photonic structures is greater than the radius of the structures. The spacing of the pattern of photonic structures in the XY-plane is shown in FIG. 2B and the dimensionality and spacing of the photonic structures in the XZ-plane are shown in FIG. 2C.

In some embodiments, the pixelated pattern of photonic structures is configured to cause light transmitted through the photonic structures to converge. In some embodiments, the pixelated pattern of photonic structures is configured to cause light transmitted through the photonic structures to propagate as a collimated plane wave. In some embodiments, the pixelated pattern of photonic structures is configured to cause light transmitted through the photonic structure to diverge.

The dimensions of the photonic structures may be based on the refractive index of the material used to form the structures. In some embodiments, a refractive index between 1.7 and 4, at the target wavelength may be used to form the structures. In the illustrated embodiment of FIGS. 2A-2C, the target wavelength is 570 nm and the photonic structures are formed from a silicon nitride based dielectric material having a refractive index of approximately 3.24 at 570 nm. In other embodiments, the target wavelength may be 650 nm.

The dimensions of the photonic structures may also be based on a desired transmission bandwidth. In some embodiments, the desired transmission bandwidth is less than 200 nm, less than 100 nm, less than 50 nm, or less than 10 nm. For example, in the illustrated embodiment of FIGS. 2A-2C, the desired transmission bandwidth is 560-590 nm. In other embodiments, the desired transmission bandwidth may be 640-670 nm.

The height and the refractive index of the photonic structure may determine the phase shift of the light that is transmitted through the respective structure. In some embodiments, the photonic structures of the pixelated pattern may have a height between 50-500 nm. In some embodiments, the photonic structures of the pixelated pattern may have a height between 200-400 nm. For example, for the embodiment represented in FIGS. 2A-2C the refractive index is approximately 3.24 and the height is approximately 280 nm. In other embodiments, where a material with a larger refractive index is used, the height may be proportionally smaller. In yet other embodiments, where a material with a smaller refractive index is used, the height may be proportionally larger.

The pixelated pattern may include a subwavelength spacing between adjacent photonic structures. In some embodiments, the pixelated pattern may include a spacing between adjacent photonic structures of 100-200 nm. In some embodiments, the pixelated pattern may include a spacing between adjacent photonic structures of 140-170 nm. In other embodiments, other spacings between adjacent photonic structures may be used that include subwavelength spacings that are capable of causing the transmitted light to be converged to the detector.

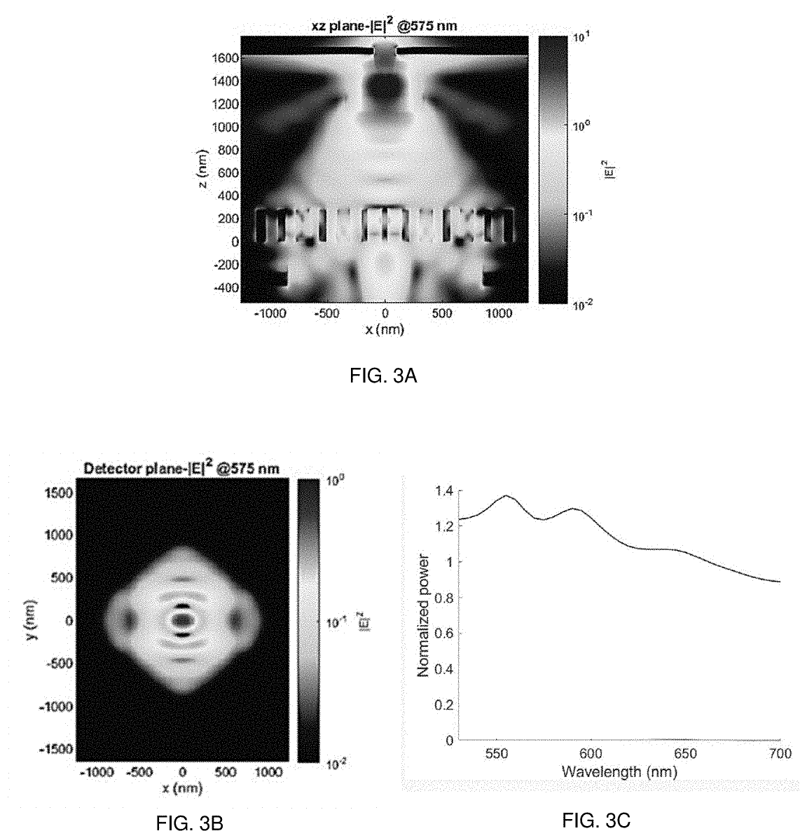

FIG. 3A is a plot of the modeled electric field of an emitter in a sample well of the integrated device that includes the photonic structures of FIG. 2A-2C, in accordance with some embodiments. As illustrated in the plot, the electric field within the device is impacted by each component in the optical path. For example, the waveguide that provides excitation light to the sample well, the top surface, the photonic structure, and the aperture impact the transmitted light. As shown in FIG. 3A, the light emitted from the sample chamber is collected by the photonic structures and converged.

FIG. 3B illustrates the electric field at the sample plane produced by the light that is transmitted through the photonic structures, as shown in FIG. 3A. As shown in FIG. 3B, the electric field is most intense in the center.

FIG. 3C illustrates the enhancement of the radiative emissions of the emitter in the sample well relative to the uncoupled emission of the emitter. Radiative coupling between the emitter in the sample well and the integrated device increases the radiative emission of light. In FIG. 3C, the emission is normalized relative to the uncoupled emission. As evident from the plot, the emission at shorter wavelengths is enhanced up to approximately 40% around 550 nm and suppressed by approximately 5% at 700 nm. The increase in the emission power may provide addition intensity for detection and may improve signal-to-noise.

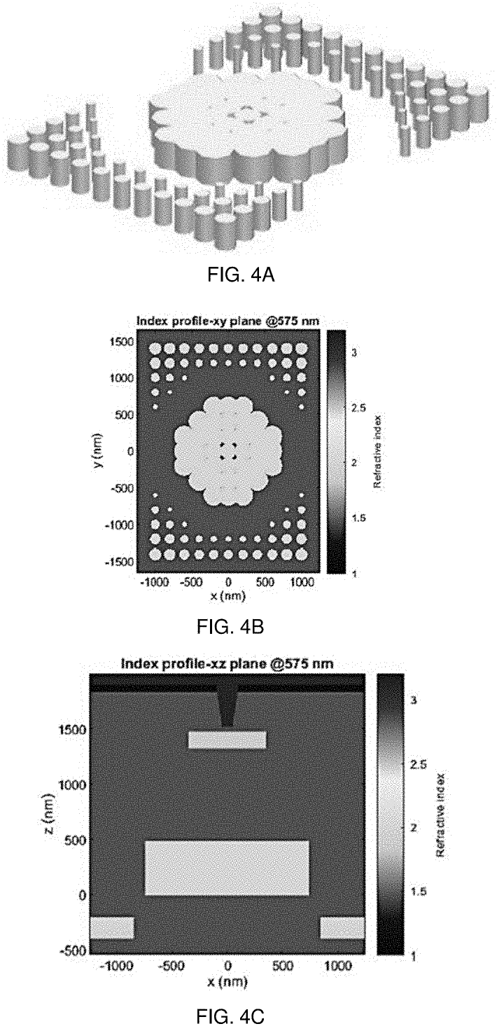

FIG. 4A illustrates an exemplary merged pattern of photonic structures, in accordance with some embodiments. As shown in FIG. 4A, for a portion of the photonic structures, the spacing between adjacent photonic structures is smaller than the radius of the respective structures. As a result, a central portion of the photonic structures form a merged photonic structure. The spacing of the pattern of photonic structures in the XY-plane is shown in FIG. 4B and the dimensionality and spacing of the photonic structures in the XZ-plane are shown in FIG. 4C.

In some embodiments, the merged pattern of photonic structures is configured to cause light transmitted through the photonic structures to converge, propagate as a collimated plane wave, or diverge as described herein.

As describe above with reference to FIGS. 2A-2C, the dimensions and spacing of photonic structures is based on the refractive index, target wavelength, desired transmission bandwidth, and/or height of the photonic structures. In the illustrated embodiment of FIGS. 4A-4C, the photonic structure is formed from silicon nitride based dielectric material having a refractive index of approximately 2.02 at 570 nm and having a height of approximately 480 nm when configured for use with a target wavelength of 570 nm. Other dielectric materials and dimensions may be used, as described herein and as known to those skilled in the art.

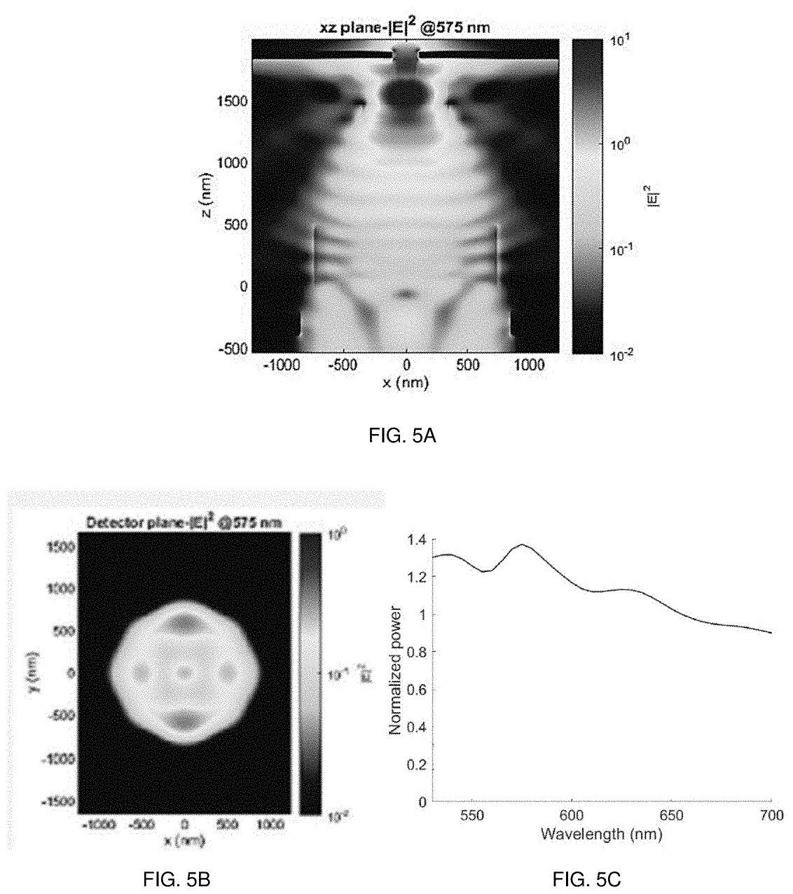

FIG. 5A is a plot of the modeled electric field of an emitter in a sample well of the integrated device that includes the photonic structures of FIGS. 4A-4C, in accordance with some embodiments. As illustrated in the plot, the electric field within the device is impacted by each component in the optical path, as described herein. In some embodiments, the merged photonic structure may have a width corresponding to the width of the aperture. The light emitted by the emitter in the sample well is collected by the photonic structures and converged.

FIG. 5B illustrates the electric field at the sample plane produced by the light that is transmitted through the photonic structures, as shown in FIG. 5A. As shown in FIG. 5B, the electric field has central spot at the sample plane with the electric field most intense at positions around the edge of the spot.

FIG. 5C illustrates the enhancement of the radiative emissions of the emitter in the sample well relative to the uncoupled emission of the emitter. Radiative coupling between the emitter in the sample well and the integrated device increases the radiative emission of light. In FIG. 5C, the emission is normalized relative to the uncoupled emission. As evident from the plot, the emission at shorter wavelengths is enhanced up to approximately 40% around 575 nm and suppressed by approximately 5% at 700 nm. The increase in the emission power may provide addition intensity for detection and may improve signal-to-noise.

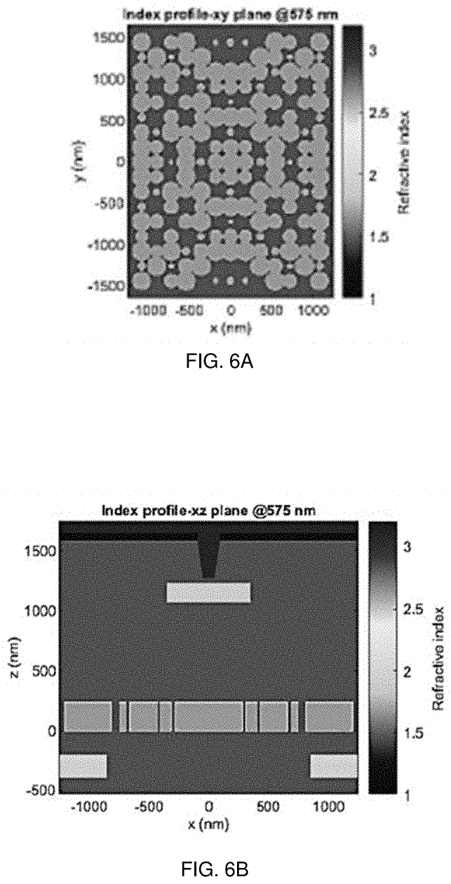

FIG. 6A illustrates another exemplary pattern of photonic structures, in accordance with some embodiments. The spacing of the pattern of photonic structures in the XY-plane is shown in FIG. 6A. For a portion of the photonic structures, the spacing between adjacent photonic structures is smaller than the radius of the respective structures. As shown in FIG. 6A, this results in merged photonic structures. The dimensionality and spacing of the photonic structures in the XZ-plane are shown in FIG. 6B.

As describe above with reference to FIGS. 2A-2C, the dimensions and spacing of photonic structures is based on the refractive index, target wavelength, desired transmission bandwidth, and/or height of the photonic structures. In the illustrated embodiment of FIGS. 6A-6B, the photonic structure is formed from titanium oxide, having a refractive index of approximately 2.63 and having a height of approximately 230 nm when configured for use with a target wavelength of 570 nm. Other dielectric materials and dimensions may be used, as described herein and as known to those skilled in the art.

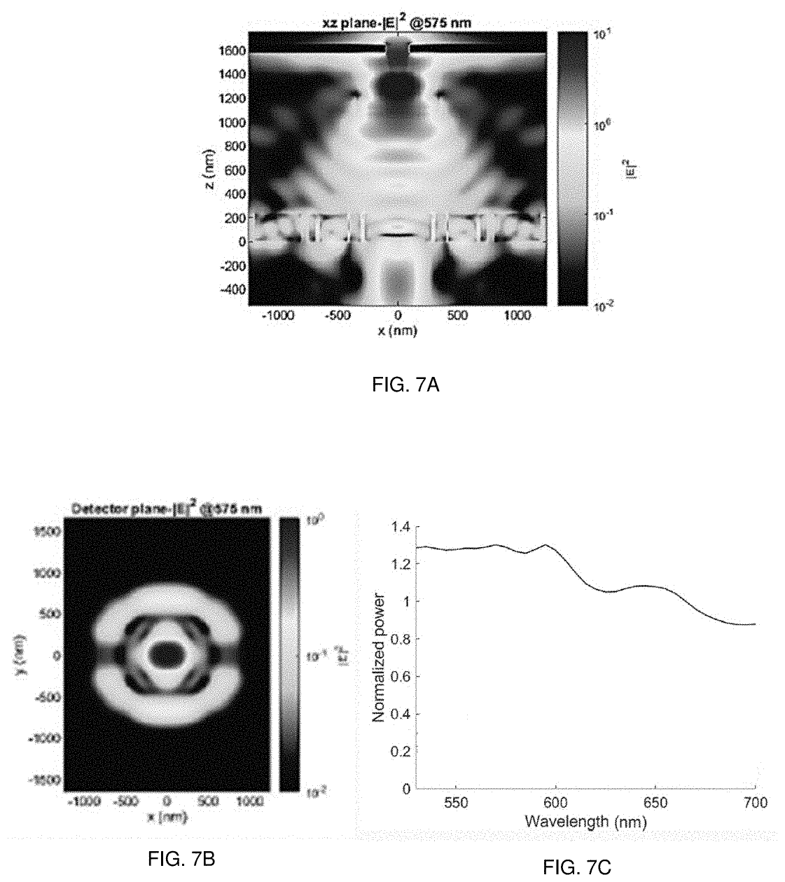

FIG. 7A is a plot of the modeled electric field of an emitter in a sample well of the integrated device that includes the photonic structures of FIGS. 6A-6B, in accordance with some embodiments. As illustrated in the plot, the electric field within the device is impacted by each component in the optical path, as described herein. The light emitted by the emitter in the sample well is collected by the photonic structures and converged.

FIG. 7B illustrates the electric field at the sample plane produced by the light that is transmitted through the photonic structures, as shown in FIG. 7B. The electric field has a central spot at the sample plane with the electric field most intense at the center with a ring-like outer emission.

FIG. 7C illustrates the enhancement of the radiative emissions of the emitter in the sample well relative to the uncoupled emission of the emitter. Radiative coupling between the emitter in the sample well and the integrated device increases the radiative emission of light. In FIG. 7C, the emission is normalized relative to the uncoupled emission. As evident from the plot, the emission at shorter wavelengths is enhanced up to approximately 30% around 600 nm and suppressed by approximately 10% at 700 nm. The increase in the emission power may provide addition intensity for detection and may improve signal-to-noise.

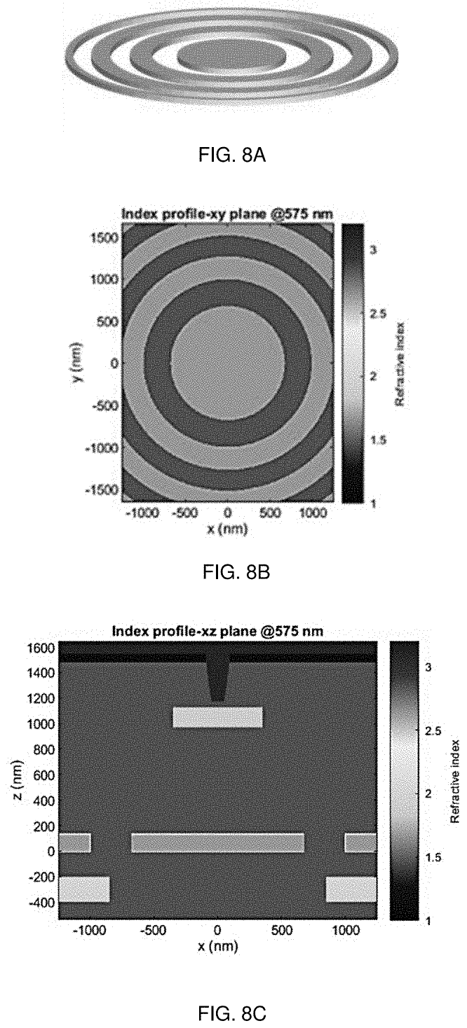

FIG. 8A illustrates an exemplary embodiment of an enhanced microdisk, in accordance with some embodiments. As shown in FIG. 8A, the enhanced microdisk includes a central disk and three ring-like photonic structures that are concentric with the central disk. The dimensions and spacing of the enhanced microdisk in the XY-plane are shown in FIG. 8B and the dimensionality and the spacing of the enhanced microdisk in the XZ-plane are shown in FIG. 8C.

In some embodiments, the enhanced microdisk photonic structures are configured to cause light transmitted through the photonic structures to converge, propagate as a collimated plane wave, or diverge as described herein.

As describe above with reference to FIGS. 2A-2C, the dimensions and spacing of photonic structures is based on the refractive index, target wavelength, desired transmission bandwidth, and/or height of the photonic structures. In the illustrated embodiment of FIGS. 8A-8C, the photonic structure is formed from a titanium oxide dielectric material, having a refractive index of approximately 2.63 and having a height of approximately 130 nm when configured for use with a target wavelength of 570 nm. Other dielectric materials and dimensions may be used, as described herein and as known to those skilled in the art.

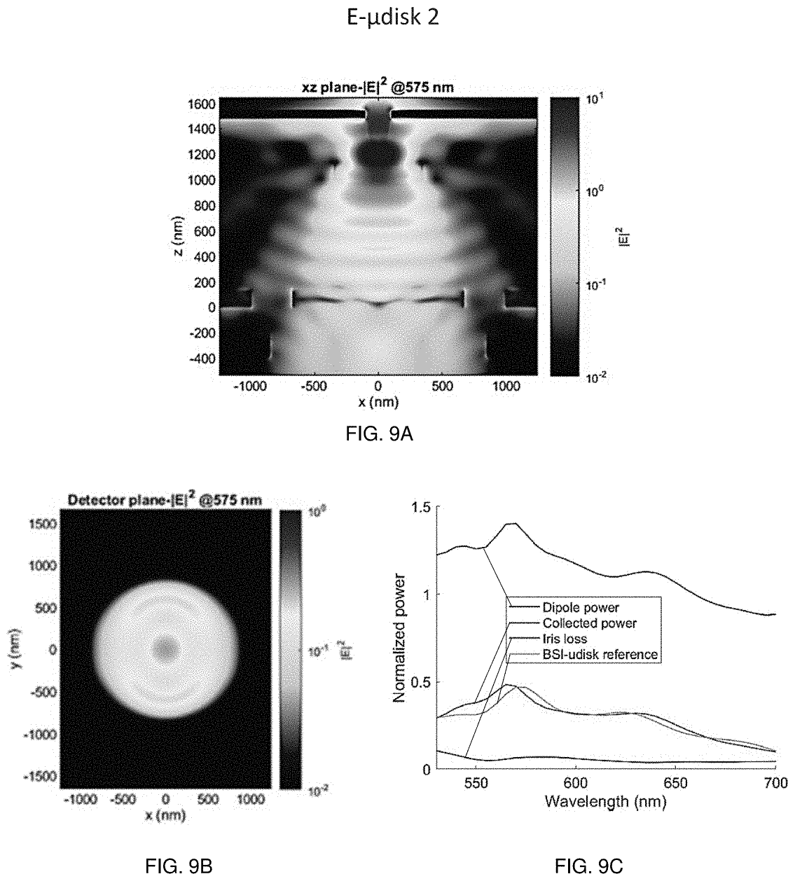

FIG. 9A is a plot of the modeled electric field of an emitter in a sample well of the integrated device that includes the photonic structures of FIGS. 8A-8B, in accordance with some embodiments. As illustrated in the plot, the electric field within the device is impacted by each component in the optical path, as described herein. The light emitted by the emitter in the sample well is collected by the photonic structures and converged.

FIG. 9B illustrates the electric field at the sample plane produced by the light that is transmitted through the photonic structures, as shown in FIG. 9A. The electric field has a circular spot in the sample plane.

FIG. 9C illustrates the enhancement of the radiative emissions of the emitter in the sample well relative to the uncoupled emission of the emitter. Radiative coupling between the emitter in the sample well and the integrated device increases the radiative emission of light. In FIG. 9C, the emission is normalized relative to the uncoupled emission. As evident from the plot, the emission at shorter wavelengths is enhanced up to approximately 45% around 575 nm and suppressed by approximately 10% at 700 nm. The increase in the emission power may provide addition intensity for detection and may improve signal-to-noise.

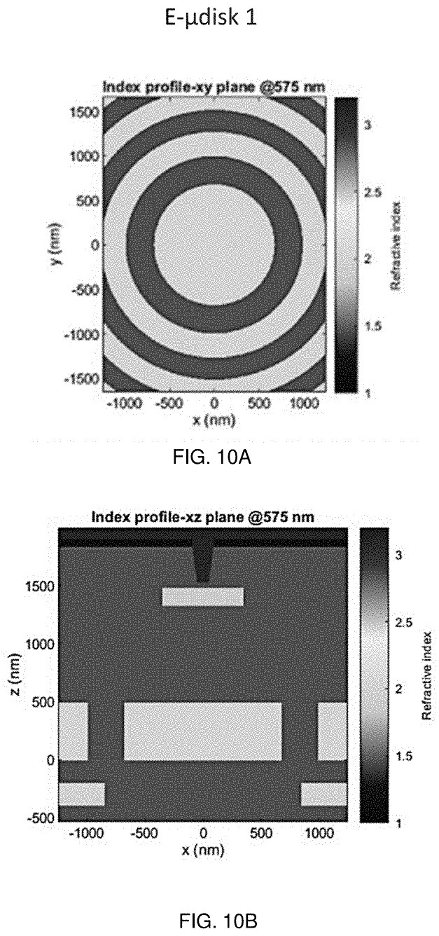

FIG. 10A illustrates another exemplary embodiment of an enhanced microdisk, in accordance with some embodiments. The dimensions and spacing of the enhanced microdisk in the XY-plane are shown in FIG. 10A. The dimensionality and the spacing of the enhanced microdisk in the XZ-plane are shown in FIG. 10B.

As describe above with reference to FIGS. 2A-2C, the dimensions and spacing of photonic structures is based on the refractive index, target wavelength, desired transmission bandwidth, and/or height of the photonic structures. In the illustrated embodiment of FIGS. 10A-10B, the photonic structure is formed from a silicon nitride based dielectric material, having a refractive index of approximately 2.02 and having a height of approximately 480 nm when configured for use with a target wavelength of 570 nm. Other dielectric materials and dimensions may be used, as described herein and as known to those skilled in the art.

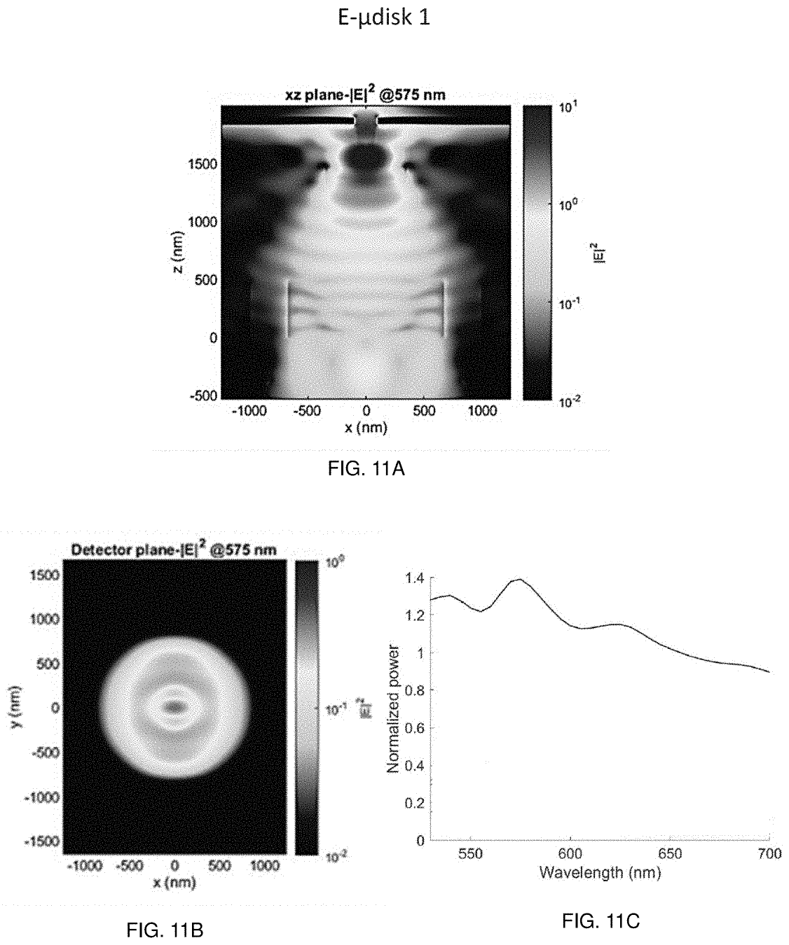

FIG. 11A is a plot of the modeled electric field of an emitter in a sample well of the integrated device that includes the photonic structures of FIGS. 10A-10B, in accordance with some embodiments. As illustrated in the plot, the electric field within the device is impacted by each component in the optical path, as described herein. The light emitted by the emitter in the sample well is collected by the photonic structures and converged.

FIG. 11B illustrates the electric field at the sample plane produced by the light that is transmitted through the photonic structures, as shown in FIG. 11A. The electric field has a circular spot in the sample plane.

FIG. 11C illustrates the enhancement of the radiative emissions of the emitter in the sample well relative to the uncoupled emission of the emitter. Radiative coupling between the emitter in the sample well and the integrated device increases the radiative emission of light. In FIG. 11C, the emission is normalized relative to the uncoupled emission. As evident from the plot, the emission at shorter wavelengths is enhanced up to approximately 40% around 575 nm and suppressed by approximately 10% at 700 nm. The increase in the emission power may provide addition intensity for detection and may improve signal-to-noise.

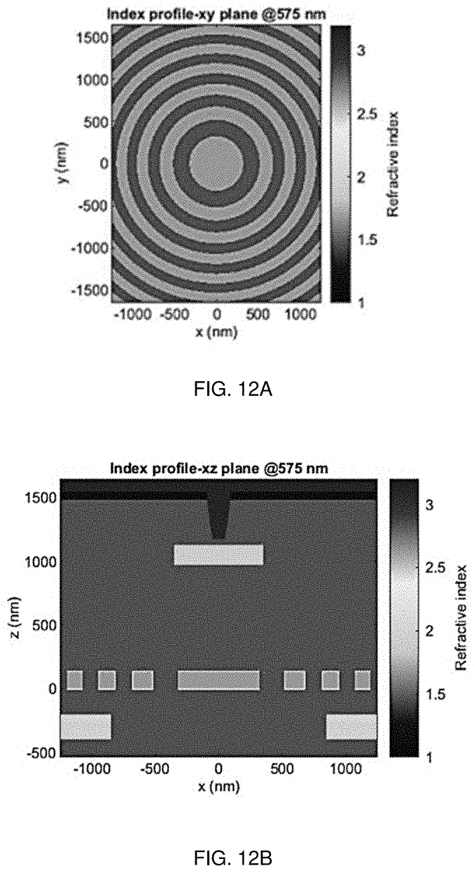

FIG. 12A illustrates yet another exemplary embodiment of an enhanced microdisk, in accordance with some embodiments. As shown in FIG. 12A, the enhanced microdisk includes a central disk and multiple ring-like photonic structures that are concentric with the central disk. The dimensions and the spacing of the enhanced microdisk in the XY-plane are shown in FIG. 12A. The dimensionality and the spacing of the enhanced microdisk in the XZ-plane are shown in FIG. 12B.

As describe above with reference to FIGS. 2A-2C, the dimensions and spacing of photonic structures is based on the refractive index, target wavelength, desired transmission bandwidth, and/or height of the photonic structures. In the illustrated embodiment of FIGS. 12A-12B, the photonic structure is formed from a silicon nitride based dielectric material, having a refractive index of approximately 2.02 and having a height of approximately 480 nm when configured for use with a target wavelength of 570 nm. Other dielectric materials and dimensions may be used, as described herein and as known to those skilled in the art.

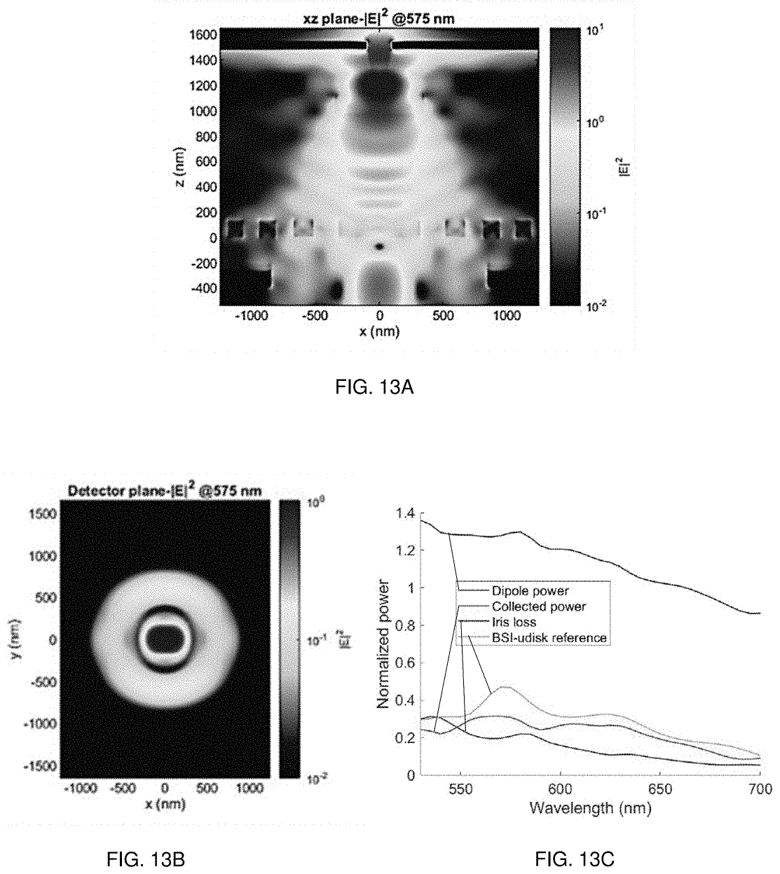

FIG. 13A is a plot of the modeled electric field of an emitter in a sample well of the integrated device that includes the photonic structures of FIGS. 12A-12B, in accordance with some embodiments. As illustrated in the plot, the electric field within the device is impacted by each component in the optical path, as described herein. The light emitted by the emitter in the sample well is collected by the structures and converged.

FIG. 13B illustrates the electric field at the sample plane produced by the light that is transmitted through the photonic structures, as shown in FIG. 13B. The electric field has a circular spot in the sample plane.

FIG. 13C illustrates the enhancement of the radiative emissions of the emitter in the sample well relative to the uncoupled emission of the emitter. Radiative coupling between the emitter in the sample well and the integrated device increases the radiative emission of light. In FIG. 13C, the emission is normalized relative to the uncoupled emission. As evident from the plot, the emission at shorter wavelengths is enhanced up to approximately 40% around 500 nm and suppressed by approximately 10% at 700 nm. The increase in the emission power may provide addition intensity for detection and may improve signal-to-noise.

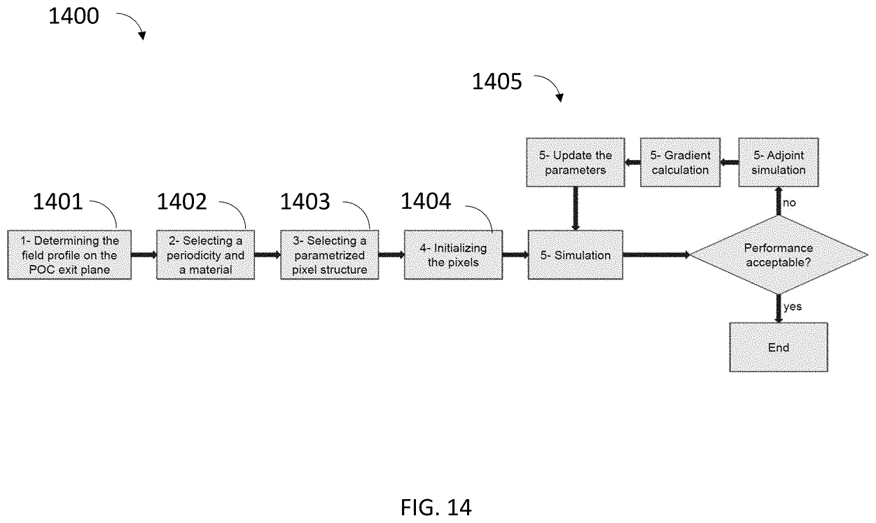

Photonic structures, such as those described above, may be designed by calculating the electric field of an emitter within an integrated device. In some embodiments, finite-element mode analysis may be used to simulate the optical properties of the photonic structures. An exemplary process for calculating photonic structures for use in an integrated device is described in FIG. 14.

FIG. 14 illustrates a process 1400 for designing the photonic structures for use in an integrated device, in accordance with some embodiments. Method 1400 determines the dimensions and spacings of photonic structures to modulate the amplitude and phase of light emitted from an emitter in the sample well to transmit a target field profile to the detector.

Process 1400 begins at block 1401 determining a target field profile of the light transmitted through the photonic structures. The target field profile includes the amplitude and the phase of the electric field directly after transmitting through the photonic structures. In some embodiments, the amplitude and phase profile can be determined based on the desired beam shape after the photonic structures. In some embodiments, the amplitude and phase profile may be determined by calculating the amplitude and phase profile that would be produced by a stack of lenses, where the stack of lenses is configured to produce a desired beam shape. For example, the desired beam shape may include converging, collimated, and/or diverging components. Additionally, or alternatively, the desired beam shape may include a beam shape or size at the detector of the integrated device.

At block 1402, a dielectric material and periodicity are selected, in accordance with some embodiments. The photonic amplitude and phase modulation of the photonic structures may be based on the contrast between the background dielectric material and the dielectric material used to form the photonic structures. In some embodiments, silicon dioxide with a dielectric constant of approximately 1.46 may be used as the background dielectric.

In some embodiments, the dielectric material of the photonic structures has a refractive index between 1.7-4. For some applications, the signal-to-noise of the integrated device may be improved by using dielectric materials that have low extinction coefficients at the target wavelength. In some embodiments, the extinction coefficient may be less than 1, less than 0.6, or less than 0.2 at the target wavelength.

Dielectric materials that provide a high refractive index (1.7-4) and low extinction coefficients include metal oxides and silicon-based materials, in accordance with some embodiments. For example, metal oxides including Titanium oxide, tantalum oxide, aluminum oxide, zirconium oxide, and hafnium oxide may be used as dielectric materials. As another example, silicon-based materials may be used in addition to or as an alternative to the metal oxides as dielectric materials, silicon-based materials include polysilicon, amorphous silicon, silicon nitride, silicon carbide, hydrogenated amorphous silicon, and alloys thereof.

The periodicity of the photonic structures may be selected based on a desired feature size at the detection plane. In some embodiments, smaller feature sizes may result in smaller features in the detection plane, while larger features may result in larger features in the detection plane. For example, comparing the features of the field profile illustrated in FIG. 9B with the features illustrated in FIG. 13B above provides an example of this difference. In both FIGS. 9B and 13B, the photonic structure used to produce the resulting features at the detection plane use the same dielectric material, as described above. However, in FIG. 13B, the intense feature in the center is distinct from the annual feature that surrounds the central feature. By contrast, in FIG. 9B, the central feature is convolved with the surrounding annual feature. In some embodiments, the periodicity is chosen such that it is less than half of the smallest desired feature size. In some embodiments, the periodicity may also be determined by the fabrication resolution.

At block 1403, the shape of the photonic structures is selected, in accordance with some embodiments. In some applications, the photonic structures may be designed to provide isotropic transmission. For example, the photonic structures may have a cylindrical shape with a circular cross-section. Although the individual photonic structures may have a cylindrical shape to provide isotropic transmission, the overall transmission of light through the photonic structures will also depend on the periodicity and dimensions of the photonic structures.

At block 1404, an initial height for the photonic structures, target wavelength, and dielectric material are initialized. In some embodiments, the dielectric material may be chosen based on a desired feature size, extinction coefficient, manufacturing parameters, and/or refractive index. In some embodiments, the target wavelength may be 570 nm or 650 nm, as described herein. In some embodiments, the initial height may be set to an odd multiple of the half-wavelength of the target wavelength. For example, the initial height may be set to the target wavelength divided by twice the value of the refractive index at the target wavelength.

At block 1405, the optical transmission through the photonic structures in a model integrated device are calculated to provide an actual field profile that results from the modification of the light emitted from the sample as it is transmitted through the photonic structures. In some embodiments, the calculated transmission may be evaluated by the transmission through the iris, absorption by the dielectric material of the photonic structure, and/or feature size. For some applications, transmission through the iris is a desirable parameter and the model may have a minimum acceptable transmission set as an input. For some applications, absorption by the dielectric material of the photonic structure may be an undesired parameter and the model may have a maximum acceptable transmission set as an input parameter. For some applications, the feature size may be based on the periodicity and manufacturing constraints, thus the model may have an input that includes a range of acceptable feature sizes.

In some embodiments, the adjoint state method may be used to calculate the gradients of the transmission parameters with respect to the model parameters. When the simulation performance has not met a target transmission through the iris, absorption by the dielectric material of the photonic structure, and/or feature size, the model parameters may be updated based on the gradient calculation.

Process 1400 ends when the simulated performance has met acceptable performance parameters. The performance parameters may include the transmission through the iris, absorption of the dielectric material of the photonic structures, and/or feature size as described herein.

As described above, the inventors have recognized and appreciated that the size of the photonic features is based at least in part on the refractive index and that taller features may lead to more defects during fabrication. To enable smaller features, the inventors have developed high refractive index materials that have low extinction coefficients.

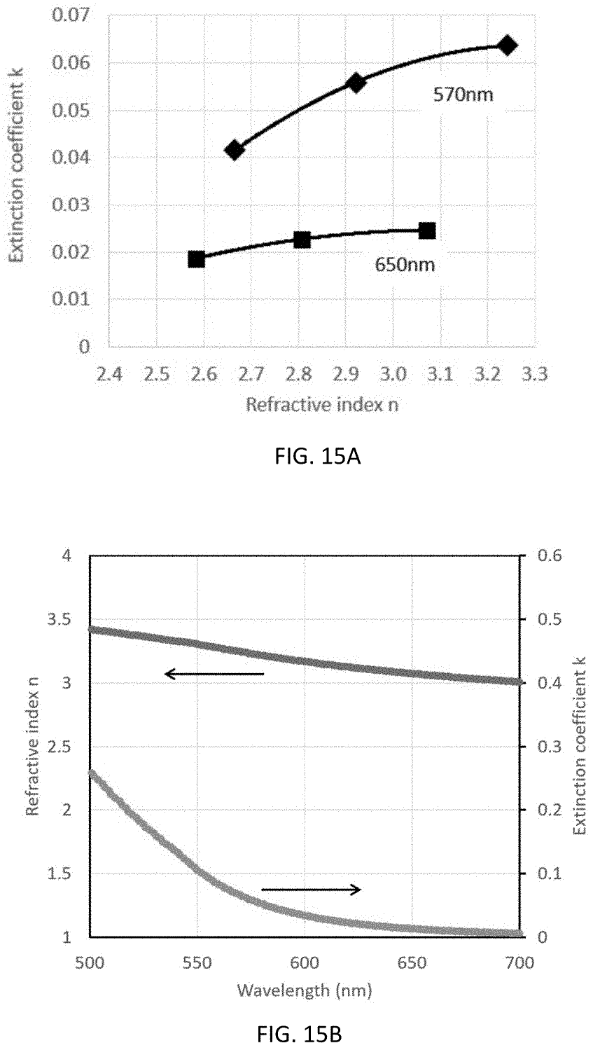

FIG. 15A shows a graph of measured refractive indices and extinction coefficients of a silicon-rich nitride material, in accordance with some embodiments. In some embodiments, the silicon-rich nitride material may be configured for use with a central wavelength of 570 nm. In other embodiments, the silicon-rich nitride material may be configured for use with a central wavelength of 650 nm. In yet other embodiments, the silicon-rich nitride material may be configured for use with other central wavelengths, where there is a corresponding emitter that would be effective for single molecule nucleic acid and/or protein detection. As shown in the chart, the refractive index may range from approximately 2.5-3.3 based on the fabrication conditions. In embodiments that are configured for use at 570 nm, the extinction coefficient may range from approximately 0.04-0.07. In embodiments that are configured for use at 650 nm, the extinction coefficient may range from approximately 0.02-0.03.

FIG. 15B illustrates the wavelength dependent refractive index and extinction coefficient for an exemplary silicon-rich nitride material. In the illustrated embodiment, the wavelength dependent refractive index ranges from approximately 3-3.5 over the range of 500 to 700 nm. For the same wavelength range, the extinction coefficient ranges from 0.3 to less than 0.1.

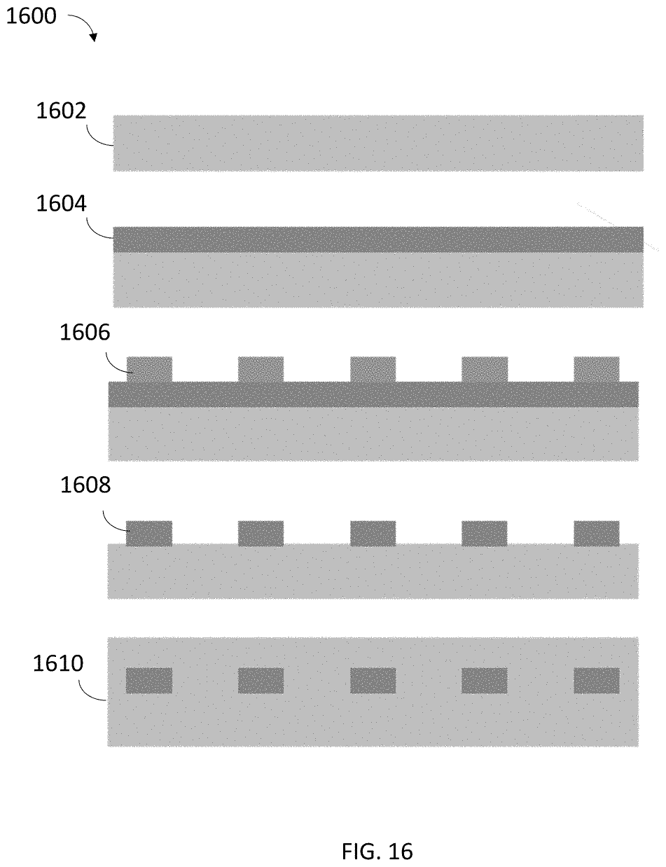

FIG. 16 illustrates a process 1600 of manufacturing photonic structures, in accordance with some embodiments described herein. Prior to the start of process 1600, a detector, detection electronics, aperture, and other base layer fabrication to provide optical or electrical connectivity to the integrated device may be fabricated on the substrate.

Process 1600 starts by preparing a top surface 1602 of the background dielectric material for deposition. In some embodiments, the background dielectric is silicon dioxide, as described herein. The background dielectric material may be deposited using chemical vapor deposition (CVD) in accordance with some embodiments. In other embodiments, other deposition techniques such as sputtering, atomic layer deposition, sol-gel, or plasma vapor deposition technique, plasma enhanced chemical vapor deposition, low pressure chemical vapor deposition, evaporation, and other oxide or non-oxide deposition techniques may be used, as aspects of the technology described herein are not limited in this respect.

Preparing the top surface of the background dielectric may involved planarizing or smoothing the top surface using a technique such as chemical mechanical polishing (CMP). Other polishing techniques may be used, as aspects of the technology described herein are not limited in this respect.

Following the preparation of top surface 1602, a layer 1604 of the photonic structure dielectric material is deposited using deposition techniques as described herein. The layer 1604 may be deposited with the desired thickness of the photonic structures.

Next, a layer of pattern resist material 1606 is deposited and patterned above layer 1604. In some embodiments, the pattern resist material may be a photoresist for patterning by exposure to light. In some embodiments, the pattern resist material may be a photoresist for patterning by exposure to an electron beam.

After exposure of the pattern resist material 1606, the exposed regions of layer 1604 are etched to form photonic structures 1608. In some embodiments, etching of the exposed regions of layer 1604 may use a plasma-based etching technique. The remaining resist material following the etch may be removed using a solvent wash.

After formation of photonic structures 1608, an overcoat of background dielectric material is deposited over and between photonic structures 1608. In some embodiments, the overcoat material may be silicon dioxide. The silicon dioxide may be deposited according to the deposition techniques described herein.

Having thus described several aspects of at least one embodiment, it is to be appreciated that various alterations, modifications, and improvements will readily occur to those skilled in the art. Such alterations, modifications, and improvements are intended to be part of this disclosure and are intended to be within the spirit and scope of the principles described herein. Accordingly, the foregoing description and drawings are by way of example only.

The terms “approximately,” “substantially,” and “about” may be used to mean with in ±20% of a target value in some embodiments, within ±10% of a target value in some embodiments, within ±5% of a target value in some embodiments, within ±2% of a target value in some embodiments. The terms “approximately,” “substantially,” and “about” may include the target value.

1. An integrated device, comprising:
a substrate having a first surface;
at least one pixel formed on or in the substrate, the at least one pixel comprising:
a reaction chamber configured to receive a sample;
a sensor configured to detect emission light emitted from the reaction chamber; and
at least one optical nanostructure disposed in a plane between a waveguide and the sensor, wherein the at least one optical nanostructure is configured to converge at least a portion of the emission light in a direction substantially perpendicular to the plane; and
the waveguide configured to couple excitation radiation to the reaction chamber.

2. The integrated device of claim 1, wherein the at least one nanostructure comprises a plurality of nanostructures disposed in the plane between the waveguide and the sensor.

3. The integrated device of claim 2, wherein the plurality of nanostructures is disposed in an array, wherein the plurality of nanostructures are configured periodically or quasi-periodically.

4. The integrated device of claim 3, wherein each of at least a subset of the plurality of nanostructures has a radius greater than or equal to the spacing between adjacent nanostructures.

5. The integrated device of claim 1, wherein a top surface of the at least one nanostructure is vertically offset from the bottom surface of the waveguide to cause constructive interference of light emitted from the reaction chamber and the at least one nanostructures.

6. The integrated device of claim 1, further comprising a metal disposed on the surface, and wherein the at least one nanostructure, the top surface, reaction chamber, and waveguide are configured to increase the radiative decay rate of a light emitted in the reaction chamber.

7. The integrated device of claim 6, wherein the surface includes a top surface of the at least one nanostructure, and wherein the top surface is within 650-950 nm of a bottom surface of the waveguide.

8. The integrated device of claim 1, further comprising:
an aperture disposed above the sensor, wherein the sensor comprises a photo-detection region, and detection electronics disposed adjacent to the detection region, and wherein the aperture is configured to reduce the transmission of light to the detection electronics.

9. The integrated device of claim 1, wherein the at least one nanostructure comprises a dielectric material with a refractive index between 2 and 3.

10. The integrated device of claim 1, wherein the at least one nanostructure is configured to provide an isotropic optical response.

11. An integrated device, comprising:
a substrate having a first surface; and
at least one pixel formed on the substrate, the at least one pixel comprising:
a reaction chamber configured to receive a sample;
a sensor configured to detect emission light emitted from the reaction chamber;
a photonic disk disposed in a plane between a waveguide and the sensor; and
at least one nanostructure ring disposed in the plane between the waveguide and the sensor, wherein the at least one nanostructure ring and the photonic disk are configured to converge at least a portion of the emission light in a direction substantially perpendicular to the plane; and
the waveguide configured to couple excitation radiation to the reaction chamber;

12. The integrated device of claim 12, wherein a top surface of the at least one nanostructure ring and the photonic disk are vertically offset from a bottom surface of the waveguide to cause constructive interference of light emitted from the reaction chamber.

13. The integrated device of claim 12, further comprising a metal disposed on the top surface, and wherein the at least one nanostructure ring, the photonic disk, the top surface, reaction chamber, and excitation waveguide are configured to increase the radiative decay rate of a light emitted from the reaction chamber.

14. The integrated device of claim 13, wherein the top surface is within 650-950 nm of the bottom surface of the waveguide.

15. The integrated device of claim 12, further comprising:
an aperture disposed above the sensor, wherein the sensor comprises a photo-detection region, and detection electronics disposed adjacent to the detection region, and wherein the aperture is configured to reduce the transmission of light to the detection electronics.

16. The integrated device of claim 12, wherein the at least one nanostructure ring and the photonic disk comprise a dielectric material with a refractive index between 2 and 3.

17. A method for fabricating an integrated device, the method comprising:
forming, on or in a substrate having a first surface, a plurality of pixels, wherein forming each pixel comprises:
forming a reaction chamber configured to receive a sample; and
forming a sensor configured to detect light emitted from the reaction chamber; and
forming at least one nanostructure in a plane between a waveguide and the sensor, wherein the at least one nanostructure is configured to converge at least a portion of the emission light in a direction substantially perpendicular to the plane; and
forming the waveguide configured to couple excitation radiation to the reaction chamber.

18. A method for determining a pattern of photonic structures for use in an integrated device, the method comprising:
determining a target field profile of light transmitted through the pattern of photonic structures;
determining, based on the target field profile of light, the pattern of photonic structures configured to modify an amplitude and phase of light emitted from a sample in a sample well of the integrated device;
determining, based on the pattern of photonic structures, an actual field profile of light transmitted through the pattern of photonic structures;
determining, based on the actual field profile of light, if a performance parameter that is indicative of light transmitted through the photonic structures is within a set range for the performance parameter.

19. The method of claim 24, further comprising when the determined performance parameter is not within the set range, updating the pattern of photonic structures based on a calculated gradient of the actual field profile, wherein the gradient is calculated using an adjoint state method.

20. The method of claim 19, wherein determining the pattern of photonic structures further comprises determining the position and size of photonic structures in the pattern of photonic structures.
